(19) United States
(12) Patent Application Publication
(10) Pub. No.: US 2025/0074839 A1
(43) Pub. Date: Mar. 6, 2025

(54) CONTROLLED RELEASE FERTILIZER

(71) Applicant: PROFILE PRODUCTS LLC, Buffalo Grove, IL (US)

(72) Inventors: Eric ROSENTHAL, Sarasota, FL (US); Brian PATTERSON, Bradenton, FL (US); Andrew Luis MERCADO, Palm Harbor, FL (US); Brandon Ellis WHITE, Ocoee, FL (US)

(73) Assignee: PROFILE PRODUCTS LLC, Buffalo Grove, IL (US)

(21) Appl. No.: 18/819,652

(22) Filed: Aug. 29, 2024

Related U.S. Application Data
(60) Provisional application No. 63/579,412, filed on Aug. 29, 2023.
(60) Provisional application No. 63/579,417, filed on Aug. 29, 2023.

(51) Int. Cl. C05G 3/40; C05G 1/00; C05G 5/10; C05G 5/30

(52) U.S. Cl. CPC C05G 3/40; C05G 1/00; C05G 5/10; C05G 5/37; C05G 5/38

(57) ABSTRACT

A control release fertilizer (CRF) includes a plurality of prills having a nutrient core including one or more type of nutrients, an external wax coating, and a plurality of internal inter-crosslinked coating layers including a blend of a biodegradable seed-oil-based polyurethane and a wax, the external coating and the plurality of internal inter-crosslinked coating layers forming a semi-permeable membrane for the one or more types of nutrients.

### CROSS-REFERENCE TO RELATED APPLICATIONS

This application claims the benefit of U.S. provisional application Ser. No. 63/579,412 filed Aug. 29, 2023; and U.S. provisional application Ser. No. 63,579,417, filed Aug. 29, 2023, the disclosures of which are hereby incorporated in their entirety by reference herein.

### TECHNICAL FIELD

The present disclosure relates to a controlled released fertilizer (CRF), especially a CRF with increased abrasion resistance, and methods of making and using the same.

### BACKGROUND

CRFs have been developed as an alternative to traditional liquid water-soluble fertilizers. CRFs are structured as coated granules which release nutrients over a period of time. Typically, they are easier to use than the liquid fertilizers and save on labor due to a single application. CRFs typically also have a reduced environmental impact. The nutrient release rate typically depends on various factors including temperature and humidity. Thus, in hot and humid environments, CRFs typically release nutrients at an accelerated rate.

### SUMMARY

In one embodiment, a CRF prill is disclosed. The CRF prill may include a nutrient core including one or more type of nutrients, an external coating formed by wax, and a plurality of internal cross-linked coating layers including a blend of polyurethane and a wax.

In one or more embodiments, a ACRF is disclosed. The CRF may include a plurality of prills having a nutrient core including one or more type of nutrients; an external wax coating; and a plurality of internal inter-crosslinked coating layers including a blend of a biodegradable plant-oil-based polyurethane and a wax, the external coating and the plurality of internal inter-crosslinked coating layers forming a semi-permeable membrane for the one or more types of nutrients. The plant-oil-based polyurethane may be based on castor oil. The plant-oil-based polyurethane may have an index ratio of —NCO groups to —OH groups of about 1.3-1.9. The nutrient core may be a single-nutrient core. The nutrient core may be a multi-nutrient core with a weight ratio of NPK of 19-6-12. The nutrient core may be a multi-nutrient core with a weight ratio of K:N of about 8:1-2:1. The plurality of internal inter-crosslinked coating layers weight may be about 1-3 wt. %, based on the total weight of the fertilizer prill. The plurality of internal inter-crosslinked coating layers may include up to two layers having the same composition. The CRF may also include a biostimulant including one or more of silicate, monosilicic acid, polysilicic acid, extract, or peptide amino acid.

In another embodiment, a CRF is disclosed. The CRF may include a plurality of prills having a nutrient core including one or more type of nutrients, a wax coating over the core, and an internal coating disposed between the external coating and the core, the internal coating having an inter-layer cross-linking, the internal coating including a blend of petroleum-based polyurethane and a wax in a weight ratio of 90-70:10-30, the external coating and the internal coating forming a semi-permeable membrane for the one or more types of nutrients, the petroleum-based polyurethane having an index ratio of —NCO groups to —OH groups of about 1.3-1.9. The petroleum-based polyurethane may be based on a two-functional polyol. The nutrient core may be a single-nutrient core. The nutrient core may be a multi-nutrient core with a weight ratio of NPK of 19-6-12. The inter-layer crosslinking may span at least two layers. The inter-layer crosslinking may be amine-based.

In yet another embodiment, a polyol mixture is disclosed. The polyol mixture may include a homogenous blend of components, weight percentages of which are based on a total weight of the polyol mixture, including about 50-95 wt. % polyol, about 0.5-30 wt. % amine crosslinker including N, N, N′, N′-tetrakis (2-hydroxypropyl) ethylene-diamine (EDTP), triethanolamine (TEOA), or both in an amount of about 0.5-30 wt. %, based on a total weight of the polyol mixture, and about 5-20 wt. % wax. The polyol may be a petroleum-based two-functional polyol. The polyol may be a plant-based biodegradable oil. The polyol may be castor oil. The polyol mixture may also include a biostimulant including one or more of silicate, monosilicic acid, polysilicic acid, extract, or peptide amino acid. The wax may be a polyolefin wax.

### BRIEF DESCRIPTION OF THE DRAWINGS

FIG. 1A is a schematic depiction of a CRF prill with a urea nutrient core, according to one or more embodiments, and a principle of nutrient release from the CRF;

FIG. 1B is a schematic depiction of another CRF prill with a multi-nutrient nutrient core, according to one or more embodiments, and a principle of nutrient release from the CRF;

FIG. 2 shows Abrasion Resistance/Release Rate data for Example 1 and Comparative Examples A and B; and

FIG. 3 shows Abrasion Resistance/Release Rate data for Example 2 and Comparative Examples C and D;

FIG. 4 shows a nutrient release curve according to the Soak Test of Examples 3-8;

FIG. 5 shows a nutrient release curve according to the Soak Test of Examples 3 and 9-14;

FIG. 6 shows a nutrient release curve according to the Soak Test of Examples 3 and 15-18;

FIG. 7A shows a nutrient release curve according to the Soak Test of Examples 3 and 19-22;

FIG. 7B shows a nutrient release curve according to the Soak Test of Examples 3 and 23-27; and

FIG. 8 shows a nutrient release curve according to the Paint Shaker test of Examples 3, 11, 15, and 23.

FIG. 9 shows a nutrient release curve according to the Soak Test of Examples 24, 26, and 29.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

CRFs, also called controlled-availability fertilizers, delayed-release fertilizers, or slow-acting fertilizers, have been developed to address environmental and economical issues associated with traditional liquid fertilizers. To name a few issues attributable to traditional fertilization products and methods, fertilizers have contributed to algal blooms, surface water contamination, groundwater pollution, soil acidification, heavy metal contamination of soils, and food contamination. Additionally, a traditional use of N—P—K (nitrogen-phosphorus-potassium) fertilizers have been suggested to cause decreasing concentrations of elements such as iron (Fe), zinc (Zn), copper (Cu), magnesium (Mg), and other trace elements in foods.

Unlike traditional water-soluble fertilizers, CRFs have been developed in a granular form, coated with substances which allow for gradual release of nutrients. CRFs thus typically have increased efficiency and can be applied just once rather than multiple times as the traditional liquid fertilizers. Additionally, CRFs may be environmentally more friendly by protecting plants from fertilization burn and reducing the overall amount of fertilizer per yield. Furthermore, CRFs may be used in agricultural, turf, and horticultural applications, and are thus a viable candidate to address problems such as growth of the world population and water shortages. CRFs may minimize the number of fertilizer applications in a growth season, thus reducing cost. CRFs may also reduce the fertilizer amounts used by about 20-30% to achieve the same yield.

Yet, many challenges remain which prevent a more wide-spread use of the CRFs. As of 2021, CRFs represented only about 1% of the total quantity of fertilizers used worldwide. One of the challenges is the ability to predetermine and control release of the nutrients from the CRF granules. Since the release rate depends on a variety of factors, tuning of the release rate remains to be a challenge. CRFs' release behavior is typically affected by temperature and humidity. While the environment may be tunable and stable in production facilities, storage and outdoor environment where the application of the CRF is conducted present challenging conditions. For example, climates with high heat, high humidity, or both, may cause the CRFs to melt, liquefy, accelerate the nutrient release rate, or a combination thereof.

Additional challenges are structural integrity and cost. Since CRFs include a fertilizer which is coated, the coating represents additional cost not associated with traditional fertilizers. While the overall cost per yield may be lower with CRFs than with traditional fertilizers, the initial investment is typically higher. To minimize the initial cost, it is desirable to minimize the thickness of the coating. Yet, too thin of a coating may be prone to structural damage from impact at the storage facility, during transportation, as well as in the field. A thinner coating may be also more susceptible to the high heat, high humidity environments, and an accelerated release rate.

Therefore, there is a need for a CRF having a predictable and stable release rate in highly challenging environments of high heat, high humidity, or both. It would be desirable that the same type of CRF may be successfully applied in additional climate conditions. It would also be desirable to develop a CRF which is impact and abrasion resistant.

In one or more embodiments, a CRF overcoming one or more of the above-mentioned disadvantages is disclosed. The CRF may be in the form of granules, prills, or the like. The CRF may include a plurality of the granules or prills having the same or different shape, size, configuration, or a combination thereof. The shape may be generally round, oval, regular, or irregular. The prills may be approximately the same size and weight.

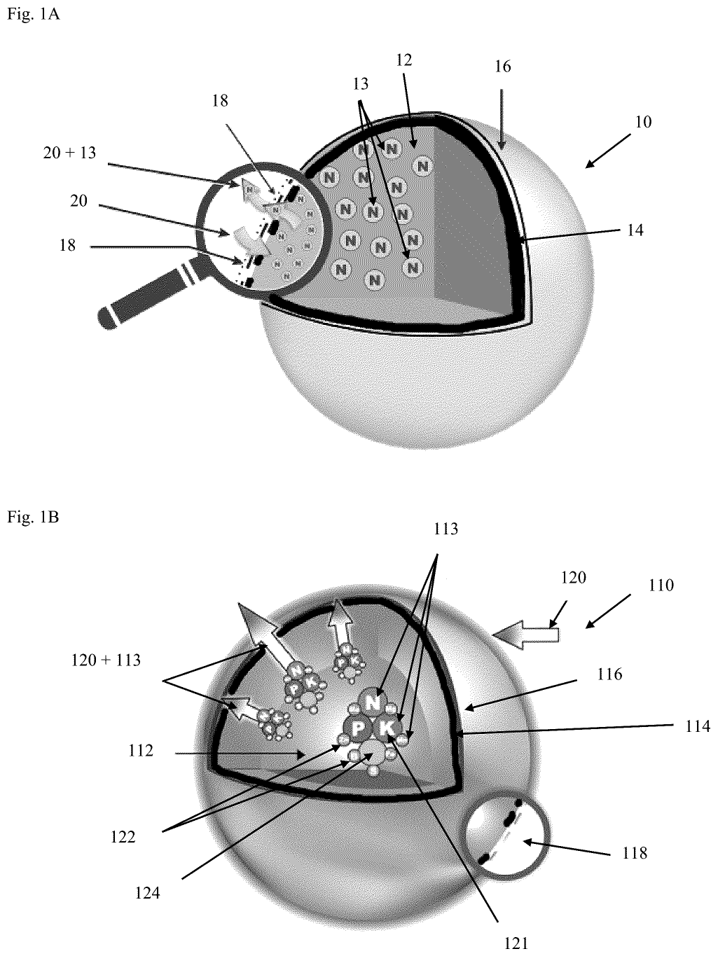

A non-limiting schematic depiction of the CRF prill disclosed herein is shown in FIG. 1A. As can be seen in FIG. 1A, the CRF prill 10 may include a nutrient core 12 with nutrients 13, one or more internal layers 14, depicted here as one layer, and an external layer 16. In the non-limiting example shown in FIG. 1A, the core 12 includes N as the core nutrient 13 to be released from the CRF 10 at a predetermined time for a predetermined time period. The nutrients 13 are released via a semipermeable membrane 18 formed by the internal coating 14, external coating 16, or both. The activation of the nutrient release is initiated by ingress of water 20, as is schematically depicted in FIG. 1A. When a sufficient amount of water 20 enters the prill 10 via the external coating 16 and the internal coating 14, the water 20 reaches the nutrients 13 in the nutrient core 12. The nutrients 13 are carried by the water 20 via the internal and/or external coatings 14, 16 out to the target. The release rate, abrasion resistance, robustness of the coatings, coating weight, and other properties discussed below, influence quantity and rate of nutrients being carried out.

FIG. 1B shows another non-limiting example of a CRF disclosed herein. As can be seen in FIG. 1B, the core 112 may be a combination core having more than one nutrient substrate 113. Specifically, the combination core 112 may include macronutrients 121, micronutrients, 122, and additional components such as a chelating agent 124. Just as with the prill depicted in FIG. 1A, the core 112 includes nutrients 113 to be released from the CRF 110 at a predetermined time for a predetermined time period. The nutrients 113 are released via a semipermeable membrane 118 formed by the internal coating 114, external coating 116, or both. The activation of the nutrient release is initiated by ingress of water 120, as is schematically depicted in FIG. 1B. When a sufficient amount of water 120 enters the prill 110 via the external coating 16 and the internal coating 114, the water 120 reaches the nutrients 113 in the nutrient core 112. The nutrients 113 are carried by the water 120 via the internal and/or external coatings 114, 116 out to the target.

The target for the non-limiting example may be an agricultural plant, crops, an ornamental plant, a nursery-grown plant, an aquatic plant, a hydroponically-grown plant, a greenhouse plant, or turf.

The CRF may include a core including one or more types of nutrients. The core may include one or more compounds including the nutrients. The core may include substrate fertilizer.

Non-limiting example compounds may include ammonium sulfate, ammonium chloride, ammonium nitrate, urea, potassium chloride, potassium sulfate, potassium nitrate, sodium nitrate, ammonium phosphate, potassium phosphate, calcium phosphate, and composite fertilizers thereof.

The nutrients may be in the form of pellets, granules, agglomerations, clusters, or a combination thereof. The nutrient type may influence its behavior resulting in different processing requirements, parameters, as well as one or more properties. For example, substrates may differ in heat retention and dissipation rates, moisture content and retention, the like, or a combination thereof.

In a non-limiting example, the substrate core may include exclusively urea and/or one or more other components which are a source of nitrogen (N). In non-limiting examples, the single nutrient core may be beneficial for agricultural plants, aquatic plants, or the like. The choice of N source such as urea may lead not only to optimal performance of the CRF in the field, but also to a more economical product due to lower rates which translates into savings, longer release rate, which increases applicability, reliability, and lowers environmental impact. Additionally, a single nutrient core such as urea substrate may have the advantage that a lower coating weight may be applied to provide adequate coverage.

In a non-limiting example, urea may be chosen as a single compound providing nutrients in the core. The nutrient core may include about 41, 42, 43, 44, 45, or 46 wt. % or more of nitrogen. The nutrient core may include at least about or about 41.0, 41.1, 41.2, 41.3, 41.4, 41.5, 41.6, 41.7, 41.8, 41.9, 42.0, 42.1, 42.2, 42.3, 42.4, 42.5, 42.6, 42.7, 42.8, 42.9, 43.0, 43.1, 43.2, 43.3, 43.4, 43.5, 43.6, 43.7, 43.8, 43.9, 44.0, 44.1, 44.2, 44.3, 44.4, 44.5, 44.6, 44.7, 44.8, 44.9, 45.0, 45.1, 45.2, 45.3, 45.4, 45.5, 45.6, 45.7, 45.8, 45.9, 46.0, 46.1, 46.2, 46.3, 46.4, 46.5, 46.6, 46.7, 46.8, 46.9 wt. % of N. The nutrient core may have the following non-limiting example composition: 46-0-0 to 44.66-0-0 to 41.8-0-0 indicating available weight % of N in the core.

Alternatively, the core may include a combination of macronutrients of nitrogen, phosphorus (P), and potassium (K) instead of strictly one type of nutrient. The NPK combination core may yield beneficial results especially for ornamentals, nursery markets, and/or as a topdress. Additionally, since an NPK combination core may be less hygroscopic than urea, the combination core coating step may be less complex as the combination core may be more stable in the presence of water and may thus be easier to coat than urea-only core. On the other hand, overall processing may be more complex since the combination core includes a plurality of different materials having different properties such as moisture retention, heat retention, etc.

The combination nutrient core may include N, P, K in various ratios suitable for the ornamentals, topdress, or nursery markets. Non-limiting example NPK weight ratios may be 21-7-14, 15-15-15, 19-6-12, 12-0-46, 3-1-2, 6-2-4, 9-3-6, 17-5-11, 16-16-16, Oct. 10, 2010, 14-4-14, May 1, 1931, May 1, 1930, May 1, 2025, Apr. 1, 2016, Mar. 1, 2012, 3-0-15, 2-1-4, 1-0-31, 1-0-8, 1-0-3, 1-0-2, or the like. In some embodiments, the cores to be coated may have three time as much N as P and twice as much as K. In at least some embodiments, the NPK ratio may have a high K to low N ratio such as 8:1-2:1, 7:1-3:1, or 6:1-4:1 such as May 1, 1930, May 1, 1931, May 1, 1930, May 1, 2025, Apr. 1, 2016, Mar. 1, 2012, 3-0-15, 2-1-4, 1-0-31, 1-0-8, 1-0-3, 1-0-2, 0-0-19, 0-0-22, 0-0-037, 0-0-047, 1-0-30, 1-0-31, 2-0-35, 2-0-38, 14-4-14, or the like.

To further cater to the ornamentals, topdress, or nursery markets, the nutrient core may include minerals such as calcium (Ca), sulfur(S), magnesium (Mg), boron (B), zinc (Zn), manganese (Mn), iron (Fe), copper (Cu), molybdenum (Mo), chlorine (Cl), nickel (Ni), or their combination. To further promote absorption of the released nutrients, one or more chelating agents may be added. The chelating agent may be an acid such as aminopolycarboxylic acid. A non-limiting example chelating agent may be ethylenediaminetetraacetic acid (EDTA). EDTA may be chosen for its ability to bind to iron and calcium ions. Other chelating agents, binding to different desirable minerals, may be chosen.

The nutrient core weight may be about 80-98, 85-98.5, or 90-97 wt. %, based on the total weight of the CRF prill. The core weight may be about, at least about, or at most about 80, 81, 82, 83, 84, 85, 86, 87, 88, 89, 90, 90.5, 91, 91.5, 92, 92.5, 93, 93.5, 94, 94.5, 95, 95.5, 96, 96.5, 97, 97.5, or 98 wt. %, based on the total weight of the CRF prill.

The CRF disclosed herein may also include one or more coatings. The coatings may have different compositions and properties such as thickness, scratch resistance, durability, permeability, etc. The coatings may form a semi-permeable membrane, penetrable by water or another liquid designed to move through the semi-permeable membrane.

The purpose of the one or more coatings is to protect the nutrients in the core for a predetermined amount of time. For example, the predetermined amount of time may be days, weeks, or months. The predetermined amount of time may be regulated depending on numerous factors such as application rate, application location, humidity, temperature, water availability, irrigation conditions such as frequency, type of irrigation, amount of water, etc. The predetermined amount of time is also influenced by factors such as handling and storage conditions.

The one or more coatings may be structured with the specific goal of providing a release of the nutrients from the core over an extended period of time such as several months to over a year. The release is a controlled release such that the one or more coatings provide a predetermined release over a predetermined time period of a predetermined amount and/or type of nutrients. In other words, the one or more coatings function as a double barrier. The double barrier prevents the nutrients coming out of the CRF too quickly and/or in too big of a quantity at once, thus protecting the plants and the environment. The double barrier also protects the core from the outside, preventing damage to the core and preventing premature, unwanted release of nutrients from the core.

To serve the dual function, the one or more coatings have to be designed according to the target release rate. Additionally, the one or more coatings may have a reduced coating weight in comparison to prior CRFs. As a result, the herein-disclosed CRFs have a more reliable release, longer release rate, and are more economical.

The one or more coatings may include an internal coating. The internal coating may be applied between the core and an outer coating. The internal coating may be applied as one or more layers. The one or more layers may have the same or different thickness, composition, and/or other properties. The one or more layers may include an outer-most layer directly adjacent to the external coating, an inner-most layer located directly adjacent the core, and one or more layers between the outer-most and inner-most layer. The one or more layers may be 1-20, 4-18, or 6-15 layers. The one or more layers may be 1, 2, 3, 4, 5, 6, 7, 8, 9, 10, 11, 12, 13, 14, 15, 16, 17, 18, 19, or 20. The internal coating may be a moisture barrier coating. While the layers are called “internal,” one of the internal coating layers may form the external or outer-most coating layer of the prill.

The layers may be or may not be individual film sheets. For example, the layers may be formed, as will be discussed below, by crosslinking between one or more materials. For example, a polyol mixture is combined with isocyanate to form PU. The polyol mixture and the isocyanate react and crosslink in a first layer applied onto the core. One or more additional layers may be applied. Each layer may be partially crosslinked before the next layer is applied. As a result, each layer may include a small amount of compounds which are not yet crosslinked. The layers may thus be intertwined by the crosslinking which happens after application of the final layer, over time. The interlayer crosslinking may provide a more robust structure and additional advantages discussed below. The degree of crosslinking of each layer before the next layer is applied may be about 70-99, 75-95, or 80-90%. The degree of crosslinking of each layer before the next layer is applied may be about, at least about, or at most about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99%. This means, that about 1-30, 5-25, or 10-20% of the cross-links may exist between layers such that the layers are inter-crosslinked, have internal-layer crosslinking, or are mutually cross-linked.

The overall coating or the internal coating weight or total coat weight of the CRF may be about, at least about, or at most about 2-20, 2.5-8, or 2.8-4.5 wt. %, based on the total weight of the CRF. The CRF may include about, at least about, or at most about 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, or 20.0 wt. % of all the coating(s) or the internal coating, based on the total weight of the CRF. It is contemplated that additional layers and greater wt. % may be achieved.

The greater the weight and thickness of the coating(s), the longer release rates may be achievable. However, too great of a weight and thickness may result in a coating which may be too expensive, bulky, impracticable from manufacturing perspective, and resulting in impracticable release rates. Thus, it is desirable to structure a product which has a balance between all the factors: cost, release rate, robustness, abrasion resistance, weight, and thickness; tailored to the end use application (i.e. crop). To achieve the desired balanced CRF, the herein-disclosed CRF may have the following coating properties and compositions.

The internal coating may generally be a structurally enhanced polyurethane (PU) coating. The PU is formed by combining a polyol mixture with an isocyanate. The polyol mixture may include one or more components. The primary component of the polyol mixture is a polyol component.

The polyol component may be a 2-functional polyol, having two available —OH (hydroxyl) groups, 3-functional polyol, having three available —OH (hydroxyl) groups, or a combination thereof, or a polyol with a greater functionality such as 4, 5, 6, 7, 8 or more-OH groups. The polyol may be a polyether polyol, polyether diol, polyether triol. In a non-limiting example, the polyol may be a nominal 400-425 molecular weight homopolymer diol. In another non-limiting example, the polyol may be based on mineral oil, paraffin oil, or their combination. The polyol may be a petroleum-based polyol. The polyol may be non-toxic to plants.

Alternatively, or in addition, the polyol may be a biodegradable polyol based on non-petroleum compounds. A non-limiting example biodegradable polyol may include a seed oil or vegetable oil or plant oil, as long as the oil is non-toxic to plants (have no phytotoxicity) and contains —OH groups. Non-limiting example oils may include castor oil, neem oil, camelina oil, almond oil, corn oil, soybean oil, canola oil, palm oil, cottonseed oil, apricot seed oil, coconut oil, safflower oil, sunflower oil, Valencia peel oil, oat oil, the like, or their combination. The oil may be refined or non-refined.

The oil-based polyol has several advantages over traditional 2-functional polyols such as a polyether polyol. Firstly, the oil-based polyol is more environmentally friendly and more economical. For example, optimal amounts of crosslinking and index ratios may lead to slower controlled releases when compared to polyether-based polyols. Secondly, it was unexpectedly discovered that the oil-based polyol may be used in amounts about half to 75% that of polyether-based polyols to obtain similar control release results. Thus, using the oil-based polyols, alone or in a combination with other components and/or polyols disclosed herein, may reduce the environmental impact and cost. Additionally, since the oils are natural oils, the seed oils require no modification which is in contrast to petroleum-based polyols. Alternatively, the oil may be modified such as by a refining process to adjust one or more properties. Additionally, the oils may be biobased and biodegradable.

For example, castor oil is a low-cost, biodegradable plant oil that may be used in polyurethanes due to its content of hydroxyl groups. Castor oil is 3-functional, having three-OH groups. Castor oil thus has a better ability to crosslink with other molecules due to the presence of extra hydroxyl groups compared to a 2-functional polyol. Castor oil also has a higher degree of hydrophobicity than most 3-functional materials. Additionally, castor oil includes a mixture of triglycerides in which about 90% of fatty acids are ricinoleates, the remainder being linoleic acid, oleic acid, stearic acid, α-linolenic acid, palmitic acid, dihydroxystearic acid, and other fatty acids. The ricinoleic acid has a hydroxyl functional group in the 12^{th} carbon atom which causes it to be more polar than most fatty acids.

The amount of polyol in the polyol mixture may be about 50-95, 70-88, or 80-85 wt. %, based on the total weight of the polyol mixture. The polyol amount may be about, at least about, or at most about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt. %, based on the total weight of the polyol mixture.

While the polyol mixture may include predominantly the polyol component, the polyol mixture may also include one or more components enhancing properties of the coating. The enhancing components may be included in the polyol mixture during manufacturing of the CRF.

Among the enhancing components may be one or more crosslinking additives. The crosslinking additives may be added to enhance scratch and abrasion resistance which are important to ensure reliable release rate. An insufficient crosslinking may provide a product which is susceptible to physical damage, abrasion, which may negatively impact the release rate as the nutrients may leave the core via a compromised coating prematurely. Thus, the PU coating may benefit from inclusion of additional component(s) which improve abrasion resistance, scratch resistance, etc. This is true especially for 2-functional polyols.

The polyol mixture may thus include a polyol cross-linking additive, cross-link density enhancer, or crosslinking agent. The crosslinking agent may be an organic compound having one or more alcohol groups. The organic compound may include a tertiary amino compound or group, a triol, an amino alcohol, or a combination thereof. Other organic compounds may include amines, diamines, or triamines.

A non-limiting example of the diamine may be N, N, N′, N′-tetrakis (2-hydroxypropyl) ethylene-diamine (EDTP or quadrol) with four available —OH groups. Another non-limiting example organic compound may be triethanolamine or trolamine (TEOA), a tertiary amino compound and a triol with the formula C₆H₁₅NO₃. TEOA is ammonia in which each of the hydrogens is substituted by a 2-hydroxyethyl group. TEOA has three available —OH groups.

When added to the polyol, the additional hydroxyl ends help increase concentration of —OH groups available for crosslinking and thus achieve greater crosslink density of the internal coating. The crosslink density, in turn, affects curing time such that the cure is accelerated. The crosslink density is defined by the density of chains or segments that connect two infinite parts of the polymer network rather than the density of crosslink junctures. The crosslinking agent may have nominal molecular weight of about 120-350, 150-300, or 200-250. The crosslinking agent may have nominal molecular weight of about, at least about, or at most about 120, 130, 140, 150, 160, 170, 180, 190, 200, 210, 220, 230, 240, 250, 260, 270, 280, 290, or 300. The crosslinking agent may have viscosity of about 60-250, 70-240, or 80-230 cp at 60° C.

The amount of cross-linking additive such as TEOA, EDTP, or their combination may be the same or different in each layer of the internal coating. The one or more cross-linking agents may be added in the amount of about 0.5-30, 2-20, or 4-10 wt. %, based on the total weight of the polyol mixture. The cross-linking agent may be added in the amount of about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 21, 22, 23, 24, 25, 26, 27, 28, 29, or 30 wt. %, based on the total weight of the polyol mixture. A higher amount may result in films are that too brittle, unsuitable for blending, bagging, and/or other post-processing handling.

The addition of the cross-linking agent increases the functionality of the polyol and overall cross-link density. For example, an addition of about 5 wt. % of the TEOA may increase functionality of the polyol from 2 to 2.5%. This seemingly incremental change may have a large impact and a significant improvement of desirable properties. Specifically, the change results in a cross-linking improvement overall and especially between chains of polymers to other chains of polymers. The overall result is an increased PU strength, integrity, robustness, abrasion resistance, release control, or their combination. In turn, the presence of the one or more cross-linkers slows down the release of the fertilizer leading to lower cost, labor, and giving plants a sustained amount of nutrient with minimal amounts of fertilizer application.

The one or more properties-enhancing components may be added to one layer, more than one layer, all of the internal coating layers. The amount and/or composition of the one or more properties-enhancing components may be the same or different throughout the internal coating layers.

The enhancing components may include a wax. The wax may be a wax mixture. The wax may be a polyethylene (PE) wax, polyolefin wax, PU wax, or a combination thereof. The wax may include compounds which are based on petroleum, synthetic, natural, hydrogenated triglycerides, paraffin, the like, or their combination. The wax may have a melting point at about 60-120, 65-115, or 67-110° C. The wax may have a melting point at about, at least about, or at most about 60, 65, 70, 75, 80, 85, 90, 95, 100, 105, 115, or 120° C. The wax may have a flash point of about 200-260, 205-240, or 210-220° C. The wax may have a bulk density in a solid form of about 0.5-0.6, 0.51-0.59, or 0.52-0.58 g/cc.

A ratio of the PU:PE in the wax mixture of the one or more internal coating layers may be about 50:50 to 98:2. The PU:PE in the wax ratio may be about, at least about, or at most about 50:50, 55:45, 45:55, 60:40, 40:60, 65:35, 35:65, 70:30, 30:70, 75:25, 25:75, 80:20, 20:80, 85:15, 15:85, 90:10, 10:90, 95:5, 5:95, 98:2, or 2:98.

A ratio of the polyol:wax in one or more internal coating layers may be about 90-70:10-30. The polyol:wax ratio may be about, at least about, or at most about 70:30, 72:28, 75:25, 78:22, 80:20, 82:18, 85:15, 88:12, or 90:10.

The amount of the one or more waxes in the coating composition may be about 5-20, 8-18, or 12-14 wt. %, based on the total weight of the polyol mixture. The wax amount may be about, at least about, or at most about 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 wt. %, based on the total weight of the polyol mixture.

Besides the components discussed above, the coating composition and/or the CRF may include one or more additional components or materials. The additional components or materials may include one or more of pigments, pigment precursors, dyes, micronutrient(s), mineral(s), mineral particle(s), biostimulant(s). The CRF may be free from one or more of pigments, pigment precursors, dyes, micronutrient(s), mineral(s), mineral particle(s), biostimulant(s).

The pigments, pigment precursors, and/or dyes may be artificial or natural-based. The pigment may be chosen for distinguishing from or blending in the application environment.

Example micronutrients may include minerals, mineral particles, boron, cobalt, chromium, copper, fluoride, iodine, iron, magnesium, manganese, molybdenum, selenium, zinc, nickel, organic acids, and phytochemicals.

Biostimulants may include any substance or microorganism that, when applied to seeds or plants, stimulates natural processes to enhance or benefit nutrient uptake, nutrient use efficiency, and/or crop quality and yield. Biostimulants may include many different types. Non-limiting example biostimulants include enzymes, proteins, amino acids, peptide amino acid, protein hydrolases and/or other N-containing compounds, micronutrients such as Ca, Al, Co, Na, Se, Si, phenols, salicylic acid, monosilicic acid, polysilicic acids, humic acid, fulvic acid, seaweed extract, botanicals, biopolymers such as chitosan, inorganic compounds such as amorphous silica (SiO_{2·}nH₂O), silicates such as potassium silicate, calcium silicate, microbial biostimulants including mycorrhizal and non-mycorrhizal fungi, bacterial endosymbionts (like Rhizobium) and Plant Growth-Promoting Rhizobacteria, fungi, fish oil, extracts including plant-based extracts, animal-based extracts, or both, etc.

In a non-limiting example, the biostimulant may include tetraethyl orthosilicate (TEOS), an organic chemical compound with the formula Si(OC₂H₅)₄, the ethyl ester of orthosilicic acid, which degrades in water and easily converts to silicon dioxide upon addition of water. In another non-limiting example, the biostimulant may include silicates, monosilicic acid, polysilicic acids, extracts, peptide amino acid, or their combination.

The one or more additional components may form a portion of the core, internal coatings, external coatings, or a combination thereof. For example, the pigment or pigment precursors may be included in one or more of the internal coating(s) via the polyol mixture.

The polyol mixture is combined with the isocyanate to form the PU coating. The isocyanate may be a suitable isocyanate such as MDI, TDI, aliphatic, aromatic, aliphatic aromatic polyisocyanates, or a combination thereof. The isocyanate is a complementary component to the polyol for PU formation.

The amount of the polyol mixture and the isocyanate, each, may be about 1-10, 1.2-5, or 1.4-2.5 wt. %, based on the total weight of a CRF prill. The respective amount of the polyol mixture, or the isocyanate, may be each about, at least about, or at most about 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, 5.0, 5.5, 6, 6.5, 7, 7.5, 8, 8.5, 9, 9.5, or 10 wt. %, based on the total weight of a CRF prill.

The isocyanate supplies the —NCO bonds within the PU. The —NCO index or index ratio of a PU is a number of equivalents of —NCO divided by the equivalents of —OH. The ratio may be obtained by dividing moles of isocyanate with moles of the polyol alone, or polyol with additional components supplying-OH groups, disclosed herein. The ratio may directly affect the controlled release/slow release rate of the fertilizer.

In one or more embodiments, the ratio of the molar amount of the polyol and the crosslinking agent with respect to the molar amount of isocyanate may be about 1 or more than 1. The molar ratio of the polyol+crosslinking agent to isocyanate may be about 1-2, 1.25-1.8, or 1.3-1.75. The molar ratio may be about, at least about, or more than about 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2.0. The disclosed ratios have another advantage, for example a lesser amount of residual isocyanate coating the production rotating drum which requires removal post-processing.

In a non-limiting example, the index ratio may be calculated based on moles of a crosslinker TEOA and a 2-functional polyether polyol. For example, the polyol+crosslinker may represent 0.5343 wt. % and the isocyanate 0.4657 wt. %, the sum of both being 1. To arrive at the index ratio, moles of the components need to be assessed. The mols of isocyanate=0.4657*1=0.4657. The mols of polyol=0.543*wt. % of the polyol in the polyol premix=0.543*0.822=0.4391. The mols of crosslinker=0.543*wt. % of the crosslinker in the polyol premix=0.5343*0.05=0.0267. The mol isocyanate is 0.4657 divided by the equivalent weight, which is a material property approximately equal to the number of —NCO bonds per mole of isocyanate. The mol polyol is 0.4391 divided by the equivalent weight which is a material property approximately equal to the number of —OH bonds per mole of the polyol. The mol crosslinker is the ratio times 0.05 divided by the equivalent weight which is a material property approximately equal to the number of —OH bonds per mole of TEOA. The mol isocyanate=0.003493, the mol polyol=0.002035, the mol TEOA=0.000537. The index ratio=sum of the mol isocyanate/(mol polyol+molds TEOA)=1.358.

The internal coating layers may have the same composition and/or quantity of materials. For example, all internal layers may be formed using the same polyol premix and isocyanate in the same ratio.

Alternatively, internal coating layers may have a different composition and/or quantity of individual components. For example, the layers may differ by the type and/or quantity of at least one component. In a non-limiting example, the inner-most layer may include a different quantity of the wax or crosslinking agent than the remaining layers. The amount of wax, polyol, crosslinking agent, additional material(s), or isocyanate may gradually increase or decrease from the inner-most layer to the outer-most layer. For example, it may be beneficial that the crosslinking is the greatest closest to the outer edge of the CRF, the external coating.

The one or more coatings may include an external coating which is applied on, around the outer portion of the core, internal coatings, or both. The external coating may be applied onto a portion or entire surface of the core or on the outer-most layer of the internal coating.

The external coating may include such components and in such quantities that the external coating enables the CRF to be stored for a predetermined amount of time, release nutrients at a predetermined rate for a predetermined amount of time, allow dissimilar CRFs to be stored next to the herein-disclosed CRF without reacting with the dissimilar CRFs, prevent atmospheric moisture from prematurely releasing nutrients from the core, the like, or a combination thereof.

The external coating may include a wax or wax mixture. The external coating wax may be different or the same as the wax in the polyol mixture described above. The wax may be a microcrystalline wax. The wax may function as an external barrier against atmospheric moisture, chemical interactions, temperature fluctuations, elevated temperature, etc.

The external coating may include more than one layer such that the wax may be applied repeatedly, similarly to the internal layers. The composition, thickness, weight, and amount of each layer of the external coating may be the same or different. The amount of the external coating may be about 0.01-0.5, 0.0.5-0.4, or 0.1-0.3 wt. %, based on the total weight of the fertilizer prill. The amount of the external coating may be about, at least about, or at most about 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.30, 0.32, 0.34, 0.36, 0.38, 0.40, 0.42, 0.44, 0.46, 0.48, or 0.5 wt. %, based on the total weight of the fertilizer prill.

A method of producing the herein-disclosed CRF is disclosed. The method may include providing a nutrient core having a desirable composition, weight, shape, configuration, etc. The method may include providing a polyol and one or more components discussed above such as a cross-linking agent and a wax. The method may include providing an isocyanate for crosslinking with the polyol mixture.

The method may include heating the nutrient core above melting temperature of the polyol mixture or the coating composition. The heating may be provided in a fluidizer preheater or another apparatus. The nutrient core may be maintained above the melting temperature of the polyol mixture for a period of time, until the polyol mixture/isocyanate are applied onto the core, or both. When urea is chosen as the single nutrient substrate, the heating may be just slightly above the melting temperature because urea has good heat retention properties. Once heated, the urea absorbs and retains the heat necessary for proper processing and coating formation.

The heating temperature may be greater than about 60-120, 65-110, or 70-100° C. The method may include heating the polyol mixture to about 99-104° C. (210-220° F.).

The method may include forming the polyol mixture by combining the polyol component with the cross-linking agent, dye, properties-enhancing components such as a biostimulant, other component(s), or their combination to form an intermediate mixture. The method may include heating the intermediate mixture above the melting temperature of the wax, dispersing the wax in the heated intermediate mixture to form a dispersion of the wax in the intermediate mixture, forming the desirable polyol mixture. Alternatively, first a dispersion of the wax in only the heated polyol may be formed, and the cross-linking agent, and/or other component(s) may be provided into the dispersion to form the desirable polyol mixture.

In another embodiment, a polyol mixture may include only the polyol, especially the oil-based polyol such as the castor oil. The polyol mixture may be thus free of a crosslinking agent, wax, dye, another component named above, or their combination.

Subsequently, the polyol mixture, still heated, may be applied onto the core. The applying may be conducted in a rotating drum or another apparatus. The applying may be provided together with the isocyanate. Alternatively, the isocyanate and the polyol mixture may be combined first and then applied onto the core. Alternatively still, the isocyanate may be applied onto the core first, followed by application of the polyol mixture.

The drum may be operated at a lower speed and rate when coating a multi-nutrient core, than for a single nutrient core, due to the complexity provided by the many components of the combination core. To address the complexities of the combination core and to ensure that the combination core is covered evenly, reliably, and to a predetermined thickness, when compared to a production of a CRF with a single nutrient core, the apparatus such as the operated drum may be run at a lower speed of about 45-55% output, the retention time may be greater than 5, 6, 7, 8, 9, 10, 11, 12, 13, 14, 15, 16, 17, 18, 19, or 20 minutes per layer, the overall production rate may be lower, the amount of applied layers of the internal coating may be greater, and/or the overall coating weight may be greater.

When applying to the core, the isocyanate, the polyol mixture, or their combination, may be each heated prior to application onto the core. Alternatively, the isocyanate may not be heated. The heating may be to a temperature which is higher than the temperature of the nutrient core. The heating may be to a temperature greater than the melting temperature of the wax in the polyol mixture. The wax may have a melting point at about 60-120, 65-115, or 67-110° C. Thus, the heating may be to above about 60-120° C. The heating may be to about, at least about, or at most about 62, 65, 67, 70, 72, 75, 77, 80, 82, 85, 87, 90, 92, 95, 97, 100, 102, 105, 107, 110, 112, 115, 117, or 120° C.

The method may include applying the polyol mixture and isocyanate onto the core to form a first layer, letting the first applied layer cool down for a predetermined amount of time. The predetermined amount of time may be about 1-25, 2-20, or 3-15 min. the predetermined amount of time may be about, at least about, or at most about 1, 2, 3, 4, 5, 6, 7, 8, 9, 10, 11, 12, 13, 14, 15, 16, 17, 18, 19, 20, 21, 22, 23, 24, or 25 min. The cooling may be assisted or unassisted. The cooling may be provided naturally as the exothermic reaction between the applied components ends. The process of applying the polyol mixture and the isocyanate may be repeated until a desirable amount of layers, thickness, weight is added onto the core.

The method may include applying the external wax coating onto the outer-most layer of the internal coating. The applying may include maintaining the core-internal coating semi-finished product at a predetermined temperature or heating the semi-finished product to the predetermined temperature. The temperature may be about 60-130, 70-120, or 80-110° C. The temperature may be about, at most about, or at least about 60, 65, 70, 75, 80, 85, 90, 95, 100, 105, 110, 115, 120, 125, or 130° C. The applying may include melting the wax to or above its melting temperature such that the wax becomes a flowing material or liquid. The applying may include letting the external coating to cool down and harden.

The method may include forming the CRFs in a desired quantity in a batch process, continuous process, or both. For example, the forming may include producing CRFs with different NPK ratios and mixing them in predetermined desirable ratios. The method may include cooling, storing, bagging, sealing, or their combination, the formed prills until dispatch to a customer.

### Experimental Section

### Examples 1, 2, and Comparative Examples A-D

CRF Examples 1, 2, and Comparative Examples A, B, C, D were prepared by the method described above. The variables between the Examples and Comparative Examples were presence or absence of TEOA, overall coating weight, and an amount of wax in the internal coating.

TABLE 1
Examples 1 and 2 and Comparative Examples A-D

| | Example | Example | Comp. | Comp. | Comp. | Comp. |
|---|---|---|---|---|---|---|
| Sample | 1 | 2 | Example A | Example B | Example C | Example D |
| Core | Urea | Urea | Urea | Urea | Urea | Urea |
| Internal | yes | yes | no | no | no | no |
| coating - | | | | | | |
| TEOA | | | | | | |
| Overall | 3.8 | 4.5 | 3.8 | 3.8 | 4.5 | 4.5 |
| coating | | | | | | |
| weight | | | | | | |
| [wt. %] | | | | | | |
| Internal | 15 | 15 | 25 | 15 | 25 | 15 |
| coating | | | | | | |
| wax | | | | | | |
| weight | | | | | | |
| [wt. %] | | | | | | |

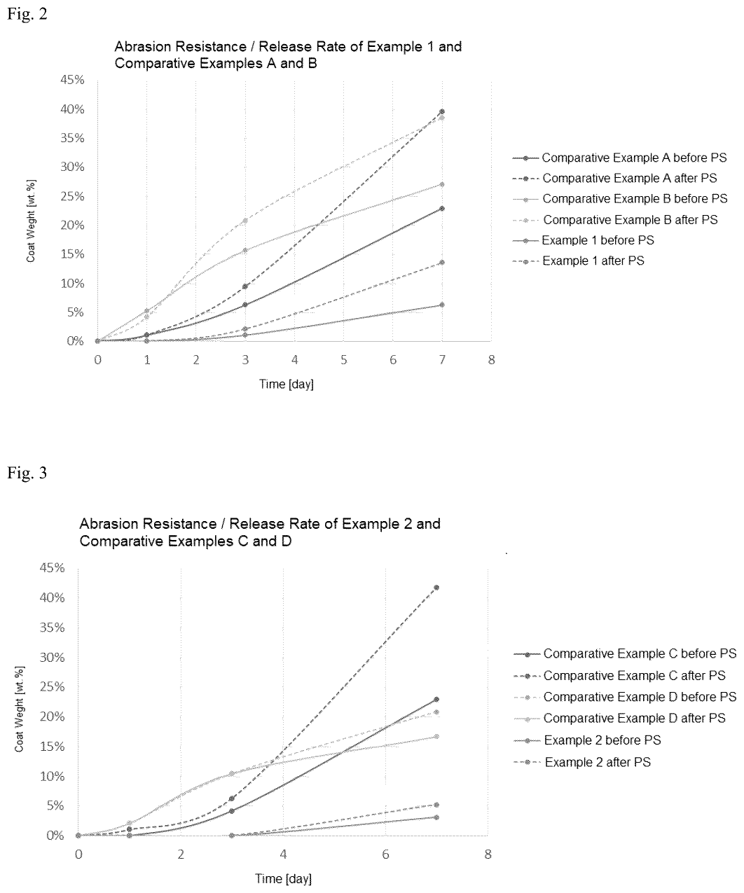

Examples 1, 2, and Comparative Examples A, B, C, D were subjected to a Paint Shaker test to assess abrasion resistance/release rate. The results are shown in FIGS. 2 and 3. As can be observed from the plots of FIGS. 2 and 3, abrasion resistance improved at high coat weights, but the most significant improvement stemmed from the addition of the crosslinking agent, TEOA. In the plots of FIGS. 2 and 3, PS refers to the Paint Shaker test.

The Paint Shaker test was conducted as follows: release rate of each Example and Comparative Example was measured using a standard release test of a measured amount of sample to a measured amount of DI water placed in an incubator of a specified temperature and then read using a refractometer. Then 200 grams of each Example and Comparative Example were separately placed in clean plastics beakers. The beakers were sealed. The beakers were secured to the shaker, Blair Tornado II Paint Shaker. The paint shaker was activated and ran for 5 minutes. After 5 minutes, the beakers were removed from the shaker. The Examples and Comparative Examples were each placed in a container, DI room temperature water was added, and abrasion resistance/nutrient release assessed on days 1, 3, and 7 using the standard release test and refractometer (described as the Soak Test in Examples 3-8). The amount of DI water added to each Example, Comparative Example was 360 g. The amount of each Example, Comparative Example was 40 g.

### Examples 3-8

Examples 3-8 included urea as a substrate including a plurality of prills, each including a single nutrient in the nutrient core. The coated nutrient core had a final weight of 1,000 grams, including the nutrient substrate (urea) and coating. The coating included four layers of isocyanate with a polyol mixture unless noted otherwise. The coating accounted for a total of 3.2 wt. % coating, based on the total weight of the prill. An external wax layer accounted for 0.150 wt. % of each prill, based on the total weight of the prill.

The composition of the polyol mixture is shown in Table 2 for all Examples 3-8.

TABLE 2
Composition of Examples 3-8

| | | Polyol | | Crosslinker | Wax + dye | |
|---|---|---|---|---|---|---|
| Example | | amount | | amount | amount | Index |
| No. | Polyol | [wt. %] | Crosslinker | [wt. %] | [wt. %] | ratio |
| 3 | 2- | 82.18 | TEOA | 5 | 12.82 | 1.35 |
| | functional | | | | | |
| | polyether | | | | | |
| 4 | 2- | 82.18 | TEOA | 5 | 12.82 | 1.5 |
| | functional | | | | | |
| | polyether | | | | | |
| 5 | 2- | 82.18 | TEOA | 5 | 12.82 | 1.3 |
| | functional | | | | | |
| | polyether | | | | | |
| 6 | Castor oil | 82.18 | TEOA | 5 | 12.82 | 1.6 |
| 7 | Castor oil | 82.18 | TEOA | 5 | 12.82 | 1.35 |
| 8 | Castor oil | 82.18 | TEOA | 5 | 12.82 | 1.5 |

The wax was added to the remaining components of the polyol mixture which was heated up to 104.4-116° C. (220-240° F.) to melt the wax component. An index ratio was counted by dividing the amounts of the polyol and crosslinking agent(s) to the isocyanate, considering their equivalent rates, molar amounts of isocyanate, and the reactivity of the polyol and the crosslinking agent(s). The index ratio relates to the molar amount of isocyanate factoring equivalent weight divided by the molar amount of —OH group materials.

The reactor and the substrate were heated to about 65.5-71.1° C. (150-160° F.) in air. The isocyanate was added first and left to react for about 2 minutes while being mixed with the substrate in the reactor. The polyol mixture was subsequently added to the reaction and left to mix and react for about 10 minutes. The cycle was repeated 4 times to form 4 internal coating layers. The external coating layer was added by applying the wax onto the substrate in the reaction and left to set for about 5 minutes. Examples 3-8 were allowed to cool to about 48.8° C. (120° F.) before bagging. Examples 3-8 were subjected to the Paint Shaker test, described above, and a Soak Test to identify percent release over time.

The Soak Test used is described herein. Each Example 3-8 was prepared as follows. 40 g of each Example 3-8 were combined with 360 mL of distilled water in a Mason jar with a lid. Each Example was then placed in an incubator at 37.8° C. (100° F.) and kept there for a time period until the fertilizer finished releasing or the experiment concluded. The Examples 3-8 were tested at intervals of Day 1, Day 3, Day 7, Day 14, Day 21, and every subsequent week (7 days) until the fertilizer finished releasing or the experiment concluded.

During the test, a refractometer was calibrated. Each Example was removed from the incubator and a clean pipette was used to obtain a small sample of the urea/water solution to be placed in the refractometer. The refractometer evaluated each Example and the value was recorded. All Examples 3-8 were returned to the incubator for the next reading on the following interval day. The recorded data was plotted to see % release of Example 3-8.

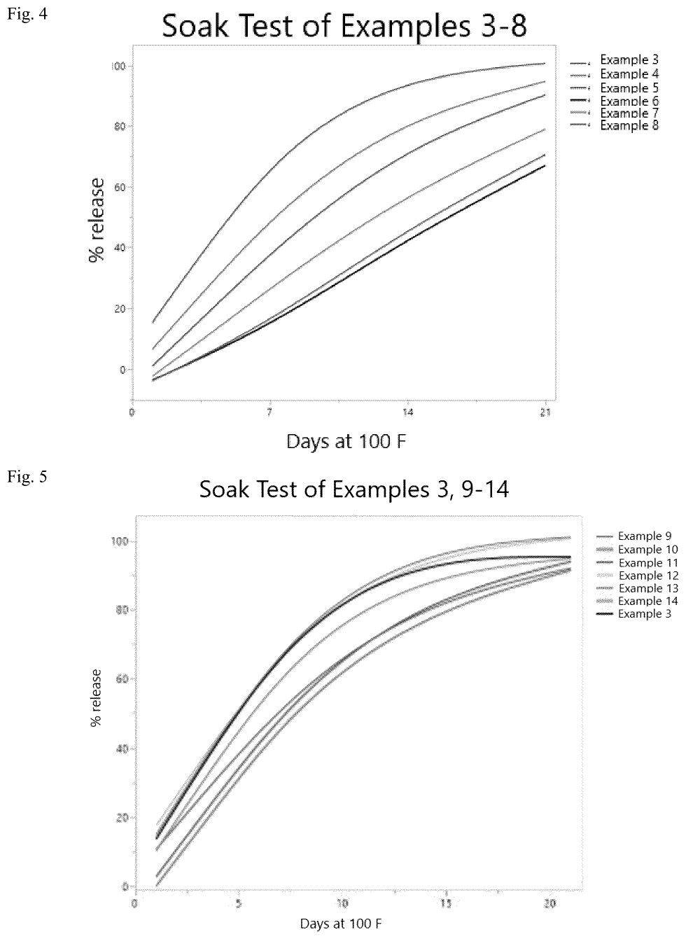

Results of the Soak Test for Example 3-8 are shown in FIG. 4. FIG. 4 is a plot of nutrient release from the prills in wt. % after 1-21 days, based on the total weight of the core. In the Soak Test plots disclosed herein, the nutrient wt. % release is marked as “% release” on axis y and the time period of release is marked as “Days at 100 F” on axis x.

### Examples 9-14

Example 9-14 were prepared according to the process described in Examples 3-8. The composition and index ratios are listed in Table 3. Examples 9-14 were prepared to assess the number of layers and material needed for a suitable coating using plant-based seed oil, castor oil, as a polyol component of choice. Table 3 and corresponding results in FIG. 5 also show Example 3 for comparison. The same amount of coating material was used in the two layers of Example 9 at 100% of material used as in Example 12 with 50% material used in four layers.

Examples 3 and 9-14 were subjected to the Soak Test described above. The results are shown in FIG. 5.

TABLE 3
Composition, number of layers and material quantity for Examples 3 and 9-14

| | | | | | | Amount of |
|---|---|---|---|---|---|---|
| | Polyol | Crosslinker | Wax + dye | | | coating material |
| Example | amount | amount | amount | Index | No. of | [% of available |
| No. | [wt. %] | [wt. %] | [wt. %] | ratio | layers | material] |
| 3 | 82.18 wt. % | 5 wt. % | 12.82 | 1.35 | 4 | 100% |
| | 2-functional | TEOA | | | | |
| | polyether | | | | | |
| 9 | 82.18 wt. % | 5 wt. % | 12.82 | 1.35 | 2 | 100% |
| | Castor oil | TEOA | | | | |
| 10 | 82.18 wt. % | 5 wt. % | 12.82 | 1.35 | 3 | 100% |
| | Castor oil | TEOA | | | | |
| 11 | 82.18 wt. % | 5 wt. % | 12.82 | 1.35 | 4 | 100% |
| | Castor oil | TEOA | | | | |
| 12 | 82.18 wt. % | 5 wt. % | 12.82 | 1.35 | 4 | 50% |
| | Castor oil | TEOA | | | | |
| 13 | 82.18 wt. % | 5 wt. % | 12.82 | 1.35 | 4 | 75% |
| | Castor oil | TEOA | | | | |
| 14 | 82.18 wt. % | 5 wt. % | 12.82 | 1.35 | 4 | 100% |
| | Castor oil | TEOA | | | | |

### Examples 15-18

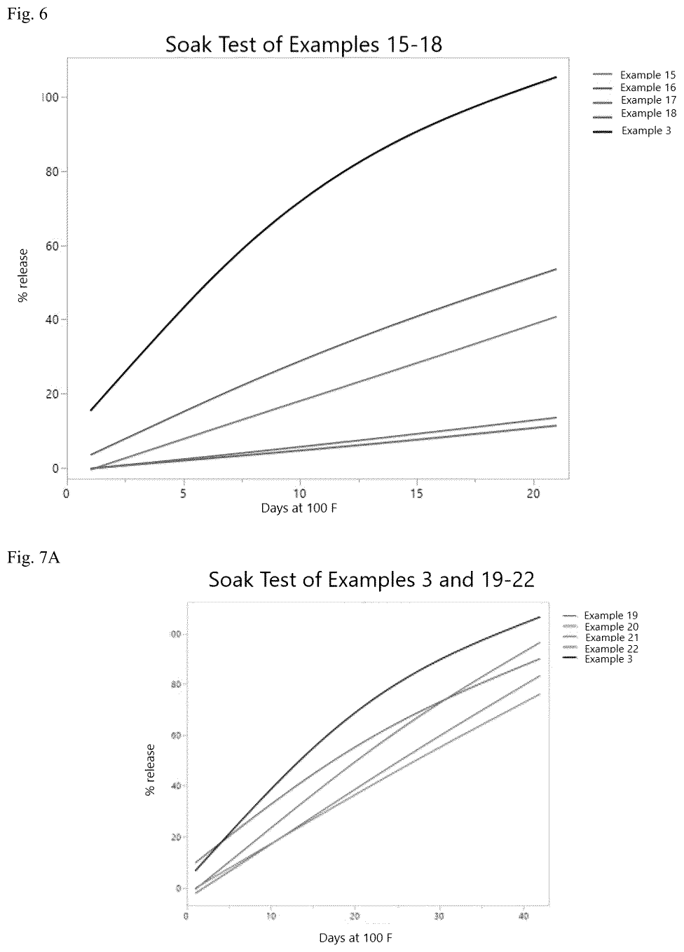

Additional castor-oil based examples were prepared with no additives. The Examples 15-18 differed by the index ratio and were compared to Example 3 including a 2-functional polyether polyol. All tested Examples had 4 layers and 100% of the material was used. As can be seen from the results of FIG. 6, Examples 15-18 released the nutrient at a slower rate than Example 3. The slower release points to a greater robustness and resilience of the coating, resulting in longer release over an extended period of time.

TABLE 4
Composition, number of layers, and amount
of material used for Example 3 and 15-18

| | | | | | | Amount of |
|---|---|---|---|---|---|---|
| | Polyol | Crosslinker | Wax + dye | | | coating material |
| Example | amount | amount | amount | Index | No. of | [% of available |
| No. | [wt. %] | [wt. %] | [wt. %] | ratio | layers | material] |
| 3 | 82.18 wt. % | 5 wt. % | 12.82 | 1.35 | 4 | 100% |
| | 2-functional | TEOA | | | | |
| | polyether | | | | | |
| 15 | 100 wt. % | — | — | 1.35 | 4 | 100% |
| | Castor oil | | | | | |
| 16 | 100 wt. % | — | — | 1.6 | 4 | 100% |
| | Castor oil | | | | | |
| 17 | 100 wt. % | — | — | 1.75 | 4 | 100% |
| | Castor oil | | | | | |
| 18 | 100 wt. % | — | — | 1.9 | 4 | 100% |
| | Castor oil | | | | | |

### Examples 19-27

Examples 19-27 were prepared as described above with a crosslinker EDTP, which was incorporated in the amounts of 5-30 wt. %, based on the total weight of the polyol premix. Table 5 shows the composition of Examples 19-27 in comparison to Example 3.

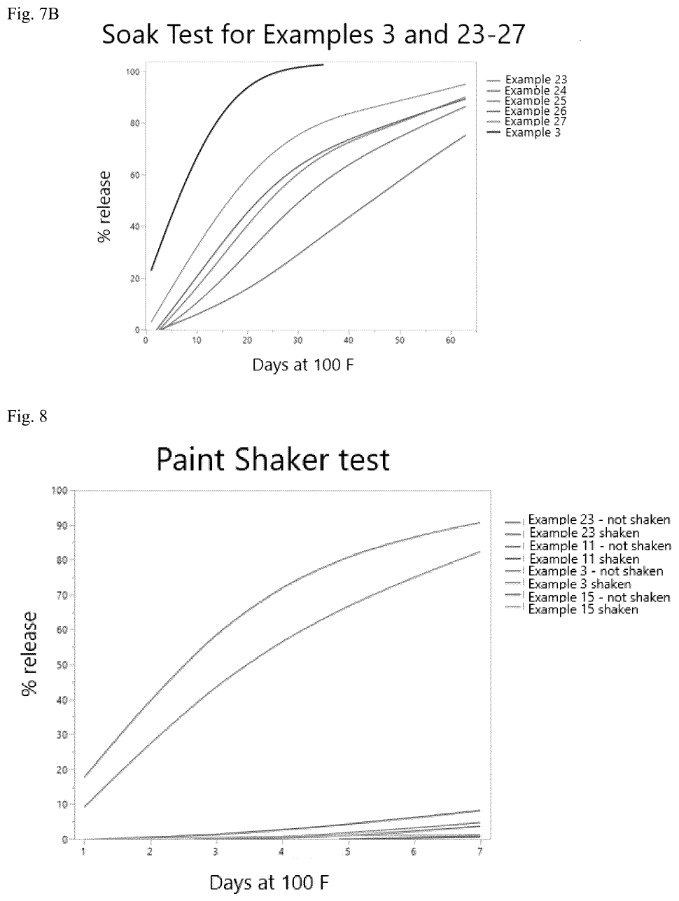

Examples 3 and 19-27 were subjected to the Soak Test, described above, results of which are shown in FIGS. 7A and 7B. Specifically, FIG. 7A shows results for Examples 3 and 19-22 and FIG. 7B for Examples 3 and 23-27. FIG. 7A shows an extended release over a period of 40 days and FIG. 7B shows an extended release over a period of 60 days.

TABLE 5
Composition of Examples 3 and 19-27

| | | Polyol | | Crosslinker | Wax + dye | |
|---|---|---|---|---|---|---|
| Example | | amount | | amount | amount | Index |
| No. | Polyol | [wt. %] | Crosslinker | [wt. %] | [wt. %] | ratio |
| 3 | 2-functional | 82.18 | TEOA | 5 | 12.82 | 1.35 |
| | polyether | | | | | |
| 19 | Castor oil | 82.18 | EDTP | 5 | 12.82 | 1.35 |
| 20 | Castor oil | 77.18 | EDTP | 10 | 12.82 | 1.35 |
| 21 | Castor oil | 67.18 | EDTP | 20 | 12.82 | 1.35 |
| 22 | Castor oil | 57.18 | EDTP | 30 | 12.82 | 1.35 |
| 23 | Castor oil | 79.68 | EDTP | 7.5 | 12.82 | 1.35 |
| 24 | Castor oil | 77.18 | EDTP | 10 | 12.82 | 1.35 |
| 25 | Castor oil | 74.68 | EDTP | 12.5 | 12.82 | 1.35 |
| 26 | Castor oil | 72.18 | EDTP | 15 | 12.82 | 1.35 |
| 27 | Castor oil | 69.68 | EDTP | 17.5 | 12.82 | 1.35 |

### Paint Shaker Test of Examples 3, 11, 15, and 23

Examples 23, 11, 3, 15 were subjected to the Paint Shaker test described above with respect to Examples 1 and 2. FIG. 8 shows the results for the Examples shaken according to the PS test and the Examples not shaken.

### Examples 24-29

Examples 24-29 were prepared according to the process described above.

Examples 24-29 included a nutrient multi-core (NPK) as a substrate. The examples included a plurality of prills. The coated nutrient core had a final weight of 1,000 grams, including the nutrient substrate and coating. The nutrient core included various NPK ratios, for example 19-6-12 and 21-7-14, respectively. The coating included four layers of isocyanate with a polyol mixture on each prill. The coating accounted for a total of about 3.2 wt. % coating, based on the total weight of the prill. An external wax layer of about 0.150 wt. %, based on the total weight of the prill, was also included. Composition of Examples 24-29 is listed in Table 6.

TABLE 6
Composition of Examples 24-29

| | | Polyol | | Crosslinker | Wax + dye | |
|---|---|---|---|---|---|---|
| Example | | amount | | amount | amount | Index |
| No. | Polyol | [wt. %] | Crosslinker | [wt. %] | [wt. %] | ratio |
| 24 | 2-functional | 82.18 | TEOA | 5 | 12.8 | 1.38 |
| | polyether | | | | | |
| 25 | 2-functional | 82.18 | TEOA | 5 | 12.82 | 1.38 |
| | polyether | | | | | |
| 26 | Castor oil | 82.18 | TEOA | 5 | 12.82 | 1.38 |
| 27 | Castor oil | 82.18 | TEOA | 5 | 12.82 | 1.38 |
| 28 | Castor oil | 82.18 | TEOA | 5 | 12.82 | 1.6 |
| 29 | Castor oil | 82.18 | TEOA | 5 | 12.82 | 1.6 |

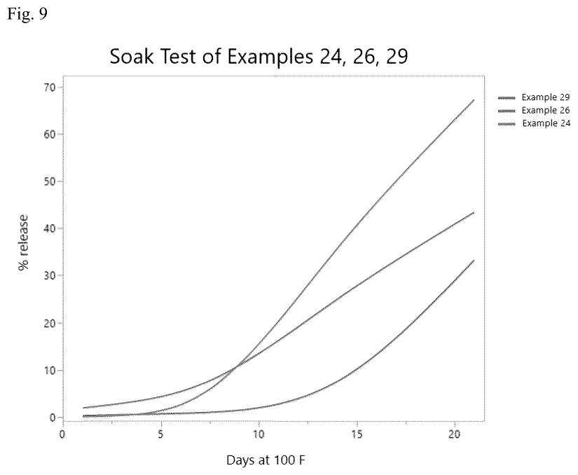

Examples 24-29 were subjected to the Soak Test described above. The release rates shown in the span of 21 days are shown in Table 7. Results for Examples 24, 26, and 29 are also shown in FIG. 9.

TABLE 7
Soak Test results for Examples 24-29

| Example | % release | % release | % release | % release | % release |
|---|---|---|---|---|---|
| No. | at day 1 | at day 3 | at day 7 | at day 14 | at day 21 |
| 24 | 0.904 | 1.864 | 4.093 | 38.786 | 68.714 |
| 25 | 0.032 | 0.408 | 2.921 | 36.929 | 68.286 |
| 26 | 2.129 | 3.757 | 6.900 | 25.857 | 42.714 |
| 27 | 0.749 | 1.943 | 5.457 | 24.357 | 43.000 |
| 28 | 0.771 | 0.338 | 1.414 | 7.393 | 34.143 |
| 29 | 0.027 | 0.888 | 0.224 | 5.586 | 32.786 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A control release fertilizer (CRF) comprising:
a plurality of prills having
a nutrient core including one or more type of nutrients;
an external wax coating; and
a plurality of internal inter-crosslinked coating layers including a blend of a biodegradable plant-oil-based polyurethane and a wax, the external coating and the plurality of internal inter-crosslinked coating layers forming a semi-permeable membrane for the one or more types of nutrients.

2. The CRF of claim 1, wherein the plant-oil-based polyurethane is based on castor oil.

3. The CRF of claim 1, wherein the plant-oil-based polyurethane has an index ratio of —NCO groups to —OH groups of about 1.3-1.9.

4. The CRF of claim 1, wherein the nutrient core is a single-nutrient core.

5. The CRF of claim 1, wherein the nutrient core is a multi-nutrient core with a weight ratio of NPK of 19-6-12.

6. The CRF of claim 1, wherein the nutrient core is a multi-nutrient core with a weight ratio of K:N of about 8:1-2:1.

7. The CRF of claim 1, wherein the plurality of internal inter-crosslinked coating layers weight is about 1-3 wt. %, based on the total weight of the fertilizer prill.

8. The CRF of claim 1, wherein the plurality of internal inter-crosslinked coating layers includes up to two layers having the same composition.

9. The CRF of claim 1, further comprising a biostimulant including one or more of silicate, monosilicic acid, polysilicic acid, extract, or peptide amino acid.

10. A control release fertilizer (CRF) comprising:
a plurality of prills having
a nutrient core including one or more type of nutrients;
a wax coating over the core; and
an internal coating disposed between the external coating and the core, the internal coating having an inter-layer cross-linking, the internal coating including a blend of petroleum-based polyurethane and a wax in a weight ratio of 90-70:10-30, the external coating and the internal coating forming a semi-permeable membrane for the one or more types of nutrients, the petroleum-based polyurethane having an index ratio of —NCO groups to —OH groups of about 1.3-1.9.

11. The CRF of claim 10, wherein the petroleum-based polyurethane is based on a two-functional polyol.

12. The CRF of claim 10, wherein the nutrient core is a single-nutrient core.

13. The CRF of claim 10, wherein the nutrient core is a multi-nutrient core with a weight ratio of NPK of 19-6-12.

14. The CRF of claim 10, wherein the inter-layer crosslinking spans at least two layers.

15. The CRF of claim 10, wherein the inter-layer crosslinking is amine-based.

16. The CRF of claim 10, further comprising a biostimulant including one or more of silicate, monosilicic acid, polysilicic acid, extract, or peptide amino acid.

17. A polyol mixture comprising:
a homogenous blend of components, weight percentages of which are based on a total weight of the polyol mixture, including:
about 50-95 wt. % polyol;
about 0.5-30 wt. % amine crosslinker including N, N, N′, N′-tetrakis (2-hydroxypropyl) ethylene-diamine (EDTP), triethanolamine (TEOA), or both in an amount of about 0.5-30 wt. %, based on a total weight of the polyol mixture; and
about 5-20 wt. % wax.

18. The polyol mixture of claim 17, wherein the polyol is a petroleum-based two-functional polyol.

19. The polyol mixture of claim 17, wherein the polyol is a plant-based biodegradable oil.

20. The polyol mixture of claim 17, wherein the polyol is castor oil.

21. The polyol mixture of claim 17 further comprising a biostimulant including one or more of silicate, monosilicic acid, polysilicic acid, extract, or peptide amino acid.

22. The polyol mixture of claim 17, wherein the wax is a polyolefin wax.
